(19) United States
(12) Patent Application Publication
(10) Pub. No.: US 2021/0053559 A1
(43) Pub. Date: Feb. 25, 2021

(54) VEHICLE HAZARD AVOIDING APPARATUS AND METHOD, AND STORAGE MEDIUM

(71) Applicants: FUZHOU BOE OPTOELECTRONICS TECHNOLOGY CO., LTD., Fuzhou, Fujian (CN); BOE TECHNOLOGY GROUP CO., LTD., Beijing (CN)

(72) Inventors: Qiaoni WANG, Beijing (CN); Yabin LIN, Beijing (CN); Heyuan QIU, Beijing (CN); Xin XIE, Beijing (CN); Sha HE, Beijing (CN); Yifang HUANG, Beijing (CN)

(21) Appl. No.: 17/043,935

(22) PCT Filed: Dec. 25, 2019
(86) PCT No.: PCT/CN2019/128271

§ 371 Date: Sep. 30, 2020

(30) Foreign Application Priority Data
Jan. 2, 2019 (CN) 201910001631.8

(51) Int. Cl. B60W 30/09; B60W 30/095; B60W 50/14; B60W 10/18; B60R 21/232; G06K 9/00

(52) U.S. Cl. CPC B60W 30/09; B60W 30/0956; B60W 50/14; B60W 2050/143; B60R 21/232; G06K 9/00805; B60W 10/18

(57) ABSTRACT

The present disclosure discloses a vehicle hazard avoiding apparatus and method, and a storage medium. The apparatus includes: a hazard identification device and a protection device; wherein the hazard identification device is configured to acquire image information and detect whether a hazard is present within a preset distance according to the acquired image information; and the protection device is configured to send a locking signal to lock wheels of the vehicle in response to a hazard detected by the hazard identification device.

### TECHNICAL FIELD

The present disclosure relates to the field of controls, in particular relates to a vehicle hazard avoiding apparatus and method, and a storage medium.

### BACKGROUND

Child safety has long been a key issue for every family.

Playing outdoors is inevitable for children during their growth, but they have low ability to identify dangers from vehicles. There are many outdoor potential safety hazards, and one of the most serious is traffic potential hazards, especially for children playing with children's vehicles (such as children's bicycles or scooters).

When a child plays with a children's vehicle, the speed is often too high for a parent to follow closely, resulting in the child out of a monitoring range of the parent; it is also possible that the parent neglects to take care of the child for a while due to some reason, resulting in the child away from the monitoring range of the parent. Under these circumstances, traffic hazards are extremely likely to occur.

### SUMMARY

In view of this, in an embodiment of the present disclosure, there is provided a vehicle hazard avoiding apparatus and method, and a storage medium for solving the following problem in the related art: traffic accidents are easy to happen when a vehicle is running at a high travel speed.

In one aspect, an embodiment of the present disclosure provides a vehicle hazard avoiding apparatus, including: a hazard identification device and a protection device; wherein the hazard identification device is configured to acquire image information and detect whether a hazard is present within a first distance according to the acquired image information; and the protection device is configured to send a locking signal to lock wheels of the vehicle in response to a hazard detected by the hazard identification device.

In some embodiments, the apparatus further includes: a hazard alarming device configured to send an alarm sound in response to the hazard detected by the hazard identification device.

In some embodiments, the hazard identification device is further configured to detect whether a hazard is present within the first distance at a time interval of a first time.

In some embodiments, the hazard identification device includes: a camera and a processor, wherein the camera is configured to acquire the image information, and the processor is configured to detect whether a hazard is present within the first distance according to the acquired image information; and wherein the camera is mounted at a head and/or a tail of the vehicle.

In some embodiments; the processor is further configured to send a notification message to a first contact when a hazard is detected.

In some embodiments, the protection device includes: a brake structure and a locking structure, wherein the brake structure is configured to reduce a wheel speed, and the locking structure is configured to securely lock a stationary wheel.

In some embodiments, the protection device further includes: a wrapping protector configured to eject a material capable of wrapping up a user in the vehicle in response to a hazard detected by the hazard identification device.

In some embodiments, the material is a high polymer material.

In some embodiments, the material has a non-sealed reticulated ellipsoid structure.

In some embodiments, the vehicle is a children's vehicle.

In another aspect, an embodiment of the present disclosure provides a vehicle hazard avoiding method, in which the vehicle hazard avoiding apparatus as described above is applied, the method including: detecting whether a hazard is present within a first distance according to the acquired image information; and sending a locking signal to lock wheels of the vehicle under the condition that a hazard is present within the first distance.

In some embodiments, after detecting whether a hazard is present within the first distance according to the acquired image information, the method further includes: sending an alarm sound under the condition that a hazard is present within the first distance, and detecting whether a hazard is present within the first distance according to the acquired image information at a time interval of a first time.

In some embodiments, the step of detecting whether a hazard is present within a first distance according to the acquired image information includes: determining whether a distance between a first vehicle and a second vehicle is smaller than the first distance according to the acquired image information; determining, under the condition that the distance is smaller than the first distance, a travel speed of the second vehicle according to the acquired image information; and detecting whether the travel speed exceeds a first travel speed.

In some embodiments, after detecting whether the travel speed exceeds the first travel speed, the method further includes: determining, under the condition that the travel speed does not exceed the first travel speed, whether an intersection region of the second vehicle with the first vehicle is present according to the travel speed and a moving speed of the first vehicle, wherein the intersection region is a region where a collision is likely to occur.

In some embodiments, after detecting whether a hazard is present within the first distance according to the acquired image information, the method further includes: sending a notification message to a first contact under the condition that a hazard is detected within the first distance.

In some embodiments, after detecting whether a hazard is present within the first distance according to the acquired image information, the method further includes: sending, under the condition that a hazard is present within the first distance, a control signal to control ejection of a material capable of wrapping up a user in the vehicle.

In another aspect, an embodiment of the present disclosure provides a storage medium storing a computer program thereon, wherein the computer program, when executed by a processor, causes steps of the above method to be implemented.

In the embodiments of the disclosure, the hazard identification device and the protection device are mounted on a vehicle, wherein the hazard identification device may detect whether a hazard is present within the preset distance, and the protection device locks wheels of the vehicle immediately upon a hazard so that the vehicle cannot continue to move forward and thus traffic accidents are prevented.

### BRIEF DESCRIPTION OF THE DRAWINGS

FIG. 1 is a first schematic structural view of a vehicle hazard avoiding apparatus provided in a first embodiment of the present disclosure;

FIG. 2 is a second schematic structural view of the vehicle hazard avoiding apparatus provided in the first embodiment of the present disclosure;

FIG. 3 is a flowchart of a vehicle hazard avoiding method provided in a second embodiment of the present disclosure; and

FIG. 4 is a block diagram illustrating an exemplary determination of whether a hazard is present within a preset distance in the vehicle hazard avoiding method according to the second embodiment of the present disclosure.

### DETAILED DESCRIPTION OF THE EMBODIMENTS

To make the objects, technical solutions and advantages of the disclosure clearer, the technical solutions in the embodiments of the disclosure will now be described clearly and completely with reference to the accompanying drawings of the embodiments of the disclosure. Obviously, the described embodiments are only a part, not all, of the embodiments of the disclosure. Based on the described embodiments of the disclosure, all the other embodiments obtained by those ordinary skilled in the art without any creative labour fall into the protection scope of the disclosure.

Unless otherwise defined, technical or scientific terms used in the present disclosure are intended to have general meanings as understood by those of ordinary skill in the art. The words “first”, “second” and similar terms used in the present disclosure do not denote any order, quantity, or importance, but are used merely for distinguishing different components. The word “comprising” or “comprises” or the like means that the element or item preceding the word includes elements or items that appear after the word or equivalents thereof, but does not exclude other elements or items. The terms “connected” or “coupled” and the like are not restricted to physical or mechanical connections, but may include electrical connections, whether direct or indirect. The words “upper”, “lower”, “left”, “right”, or the like are merely used to indicate a relative positional relationship, and when an absolute position of the described object is changed, the relative positional relationship may also be changed accordingly.

To maintain the following description of the embodiments of the present disclosure clear and concise, a detailed description of known functions and known components is omitted from the present disclosure.

A first embodiment of the present disclosure provides a vehicle hazard avoiding apparatus, which may be applied to a motor vehicle, or may be applied to a children's vehicle. The apparatus has a structure as shown in FIG. 1, including:

a hazard identification device 1 and a protection device 2. The hazard identification device 1 is configured to acquire image information and detect whether a hazard is present within a preset distance according to the acquired image information; and the protection device 2 is connected to the hazard identification device 1 and configured to send a locking signal to lock wheels of the vehicle in response to a hazard detected by the hazard identification device.

In the embodiments of the disclosure, the hazard identification device and the protection device are mounted on a vehicle, wherein the hazard identification device may detect whether a hazard is present within the preset distance, and the protection device locks wheels of the vehicle immediately upon a hazard so that the vehicle cannot continue to move forward and thus traffic accidents are prevented.

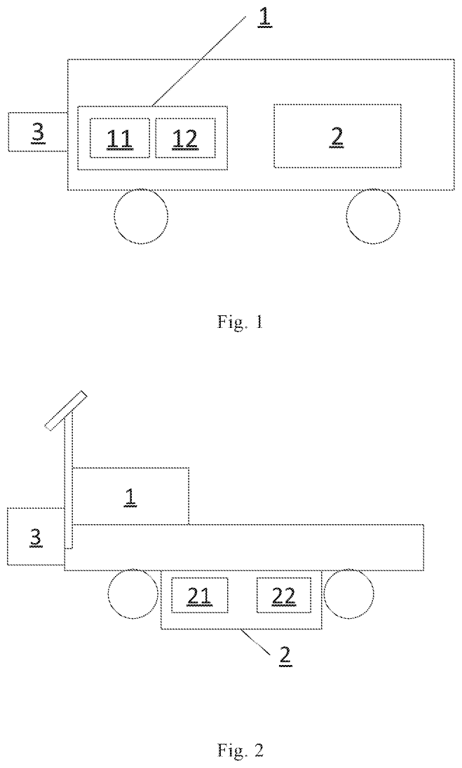

When the solution is applied to a children's vehicle, the life safety of a child playing with the children's vehicle can be guaranteed, and when the vehicle hazard avoiding apparatus is provided on a children's vehicle, it may have a structure as shown in FIG. 2.

In configuration, the hazard identification device may be arranged at different positions depending on the type of the vehicle, such as at a rear view mirror or a tail or other positions of the vehicle. FIG. 2 is merely an example of the structural relationship. For example, when the children's vehicle is a children's bicycle, the hazard identification device may be mounted in a central position between two handles of the bicycle; and when the children's vehicle is a scooter, the hazard identification device may be mounted on a handle supporting rod of the scooter.

The vehicle hazard avoiding apparatus may further include: a hazard alarming device 3 that is connected to the hazard identification device 1 and configured to send an alarm sound in response to the hazard detected by the hazard identification device. Depending on different application scenarios, the alarm sound may remind a driver or a parent of the child, or may remind passing vehicles to pay attention to the child.

In order to determine safety of the user, the above-described hazard identification device 1 is further configured to detect whether a hazard is still present within a preset distance at a preset time interval. If a hazard is still present, the hazard alarming device 3 may send a more urgent alarm sound, or may further turn up the volume, so as to obtain a better warning effect.

The hazard identification device 1 may be implemented by a camera 11 and a processor 12 together. The camera 11 is configured to acquire the image information, and the processor 12 is configured to detect whether a hazard is present within a preset distance according to the acquired image information. The camera 11 may be mounted on a head and/or a tail of the vehicle. Specifically, two, three or more cameras may be provided. For example, when two cameras are provided, one of the cameras may be disposed on a left side of the vehicle, and the other on a right side of the vehicle. In the case of a children's vehicle, the two cameras may be disposed on outer sides of a left handlebar and a right handlebar, and when three cameras are provided, the outer side of the left handlebar, the outer side of the right handlebar and a tail of the vehicle may be each provided with one camera.

To further secure safety of the user, the processor 12 is further configured to send a notification message to a preset contact when a hazard is detected. For example, a notification may be sent to a preset user, or a phone call or a short message may be sent to a preset number, via an APP. If the vehicle is a children's vehicle, the preset number may be generally set to a parent's telephone number, and in implementations, the parent can pay more rapid attention to the fact that the child may be in danger now by means of sending a short message or a phone call to the telephone number immediately.

The purpose of the protection device is to lock wheels of the vehicle, but in order to prevent the situation that the sudden locking of the wheels during the user's riding at a high speed would cause the user to have an impact due to inertia, the protection device 2 may include: a brake structure 21 and a locking structure 22, wherein the brake structure 21 is configured to reduce a wheel speed, and the locking structure 22 is configured to securely lock a stationary wheel. In specific implementations, the brake structure 21 may be firstly controlled to rapidly reduce the speed until braking, and then the locking structure 22 is controlled to lock the wheel.

In order to further secure safety of the user and minimize injury to the user even in the case of a hazard, the protection device may further include: a wrapping protector configured to eject a material capable of wrapping up a user in the vehicle in response to a hazard detected by the hazard identification device. The material may be a high polymer material, and may have a non-sealed reticulated ellipsoid structure with better protection performance.

When the vehicle is a children's bicycle, the wrapping protector may be disposed in a seat portion of the vehicle, and the material wrapping the child is ejected from a bottom of the seat when it is determined that a hazard is present; and when the vehicle is a scooter, the wrapping protector may be disposed on a handle supporting rod of the scooter. In this way, the child will not be injured even if he/she falls, and the risk is further minimized.

For example, when the hazard identification device identifies a passing vehicle, the acquired image is further processed to judge a travelling intention of the vehicle; when the hazard identification device finds a passing vehicle, the hazard alarming device is triggered to work and send an alarm sound to remind the passing vehicle of slowing down; when the hazard identification device identifies that the vehicle speed is low (less than 20 km/h) and the vehicle has a deceleration intention, the protection device is triggered to lock wheels of the children's vehicle so that the children's vehicle stays in place, and the child is prevented from continuing travelling to cause an accident. When the hazard identification device identifies that the vehicle speed is high and the vehicle has no deceleration intention, the protection device is triggered to work, and in addition to locking wheels of the children's vehicle, the protection device further sends an emergency short message or a phone call to the parent to remind the parent of paying attention, while a protective cover is popped up to wrap up for protection. This protective cover, which has certain flexibility and cushioning and is deformable, stretches out from the protection device, has a non-sealed reticulated ellipsoid structure and certain cushioning, but will lead to airtight stifling of children. The protective cover is mounted at the head and the tail of the children's vehicle, extends out from the head to the tail, and is finally fixed at the tail.

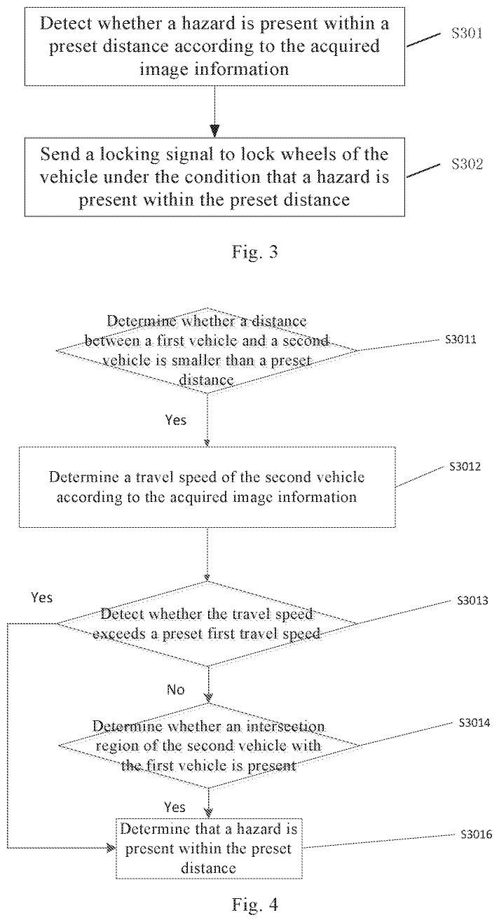

A second embodiment of the present disclosure provides a vehicle hazard avoiding method, in which the vehicle hazard avoiding apparatus as described in the first embodiment is applied. A flow of the method is as shown in FIG. 3, which includes steps S301 to S302.

At S301, it is detected whether a hazard is present within a preset distance according to the acquired image information; and

at S302, a locking signal is sent to lock wheels of the vehicle under the condition that a hazard is present within the preset distance.

In the embodiments of the present disclosure, it is detected whether a hazard is present within a preset distance according to the acquired image information; and wheels of the vehicle are locked immediately upon a hazard so that the vehicle cannot continue to move forward and thus traffic accidents are prevented. When the solution is applied to a children's vehicle, the life safety of a child playing with the children's vehicle can be guaranteed.

In order to determine safety of the user, under t condition that a hazard is present within the preset distance, an alarm sound is further sent, and it is detected whether a hazard is present within the preset distance according to the acquired image information at a preset time interval. Depending on different application scenarios, the alarm sound may remind a driver or a parent of the child, or may remind passing vehicles to pay attention to the child.

At S301: in the detection of whether a hazard is present within the preset distance according to the acquired image information, more accurate detection conditions may be set. For example, as shown in FIG. 4, at 53011: it is determined whether a distance between the user-driven vehicle and the passing vehicle is smaller than a preset distance according to the acquired image information. If smaller than the preset distance, at S3012: a travel speed of the passing vehicle is determined according to the acquired image information; and at S3013: it is detected whether the travel speed exceeds a preset travel speed. At this time, if the travel speed of the second vehicle exceeds the preset travel speed, turn to S3016, i.e., it is determined that a hazard is present. Apparently, it is also possible to further set the detection condition, i.e., in the case that the travel speed does not exceed the preset travel speed, at S3014: it is determined whether an intersection region of the passing vehicle with the user-driven vehicle is present according to the travel speed and the moving speed of the user-driven vehicle, wherein the intersection region is a region where a collision is likely to occur. At this time, if an intersection region is present; it may be immediately jumped to 53016, i.e., determining that a hazard is present. Those skilled in the art can set more conditions for detecting whether a hazard is present within the preset distance according to the above disclosure and practical situations, and details are not described here.

Because of the processor and the wrapping protector provided in the vehicle hazard avoiding apparatus, a notification message may be sent to a preset contact under the condition that a hazard is present within the preset distance. For example, a notification may be sent to the user, or a phone call or a short message may be sent to a preset number, via an APP, and a control signal may be sent to control ejection of protection measures such as a material that can wrap the user, so as to further secure safety of the user.

A third embodiment of the present disclosure provides a storage medium storing a computer program thereon, wherein the computer program, when executed by a processor, causes the method according to any of the embodiments of the disclosure, such as the following steps S1 to S2, to be implemented.

At S1, it is detected whether a hazard is present within a preset distance according to the acquired image information; and at S2, a locking signal is sent to lock wheels of the vehicle under the condition that a hazard is present within the preset distance.

After being executed by the processor to implement the step of detecting whether a hazard is present within the preset distance according to the acquired image information, the computer program is further executed by the processor to implement the step of: sending an alarm sound under the condition a hazard is present within the preset distance, and detecting whether a hazard is present within the preset distance according to the acquired image information at a preset time interval.

When being executed by the processor to implement the step of detecting whether a hazard is present within the preset distance according to the acquired image information, the computer program is specifically executed by the processor to implement the step of: determining whether a distance between a first vehicle and a second vehicle is smaller than the preset distance according to the acquired image information; determining, under the condition that the distance is smaller than the preset distance, a travel speed of the second vehicle according to the acquired image information; and detecting whether the travel speed exceeds a preset travel speed.

After being executed by the processor to implement the step of detecting whether the travel speed exceeds the preset travel speed, the computer program is further executed by the processor to implement the step of: determining, under the condition that the travel speed does not exceed the preset travel speed, whether an intersection region of the second vehicle with the first vehicle is present according to the travel speed and a moving speed of the first vehicle, wherein the intersection region is a region where a collision is likely to occur.

After being executed by the processor to implement the step of detecting whether a hazard is present within the preset distance according to the acquired image information, the computer program is further executed by the processor to implement the step of: sending a notification message to a preset contact under the condition that a hazard is detected within the preset distance, and sending a control signal to control ejection of a material capable of wrapping up a user in the vehicle.

In the embodiment of the present disclosure, it may detect whether a hazard is present within a preset distance according to the acquired image information, and wheels of the vehicle are locked immediately upon a hazard so that the vehicle cannot continue to move forward and thus traffic accidents are prevented.

Optionally, in this embodiment, the storage medium may include, but is not limited to: a U Disk, a read-only memory (ROM), a random access memory (RAM), a mobile hard disk, a disk or optical disk, and other media that can store a program code. Optionally, in this embodiment, the processor executes the steps of the method described in the above embodiment according to the stored program code in the storage medium. Optionally, specific examples in the present embodiment may refer to the examples described in the foregoing embodiments and optional implementations, which will not be repeated in the present embodiment. Obviously, a person skilled in the art would understand that the above modules and steps of the present disclosure can be realized by using a universal computing device, can be integrated in a single computing device or distributed on a network that consists of a plurality of computing devices; and alternatively, they can be realized by using the executable program code of the computing device, so that they can be stored in a storage device and executed by the computing device, in some cases, can perform the shown or described steps in a sequence other than herein, or they are made into various integrated circuit modules respectively, or a plurality of modules or steps thereof are made into a single integrated circuit module, thus to be realized. In this way, the present disclosure is not restricted to any particular hardware and software combination.

Moreover, although exemplary embodiments have been described herein, the scope thereof includes any and all embodiments based on the disclosure having equivalent elements, modifications, omissions, combinations (e.g., of various embodiments across), adaptations or alterations. The elements in the claims are to be interpreted broadly based on the language employed in the claims and not limited to examples described in the present specification or during implementation of the application, which examples are to be construed as non-exclusive. It is intended, therefore, that the specification and examples are to be considered as exemplary only, with a true scope and spirit being indicated by the following claims and their full scope of equivalents.

The above description is intended to be illustrative, and not restrictive. For example, the above examples (or one or more versions thereof) may be used in combination with each other. For example, other embodiments may be utilized by those of ordinary skill in the art upon reading the foregoing description, in addition, in the foregoing detailed implementations, various features may be grouped together to streamline the disclosure. This should not be interpreted as an intention that a non-claimed disclosed feature is essential to any claim. Rather, the subject matter of the present disclosure may lie in less than all features of a particular disclosed embodiment. Thus, the following claims are hereby incorporated into the detailed description as examples or embodiments, with each claim standing on its own as a separate embodiment, and it is contemplated that the embodiments can be combined with each other in various combinations or arrangements. The scope of the disclosure should be determined with reference to the appended claims, along with the full scope of equivalents to which such claims are entitled.

Although the present disclosure has been described in detail with reference to various embodiments, it should be understood that the present disclosure is not limited to those precise embodiments, and that various changes and modifications may be effected therein by one skilled in the art based on the concepts of the present disclosure, which changes and modifications all fall into the scope of the present disclosure.

1. A vehicle hazard avoiding apparatus, comprising:
a hazard identification device and a protection device; wherein
the hazard identification device is configured to acquire image information and detect whether a hazard is present within a first distance according to the acquired image information; and
the protection device is configured to send a locking signal to lock wheels of the vehicle in response to a hazard detected by the hazard identification device.

2. The vehicle hazard avoiding apparatus according to claim 1, further comprising:
a hazard alarming device configured to send an alarm sound in response to the hazard detected by the hazard identification device.

3. The vehicle hazard avoiding apparatus according to claim 1, wherein the hazard identification device is further configured to detect whether a hazard is present within the first distance at a time interval of a first time.

4. The vehicle hazard avoiding apparatus according to claim 1, wherein the hazard identification device comprises:
a camera and a processor, wherein the camera is configured to acquire the image information, and the processor is configured to detect whether a hazard is present within the first distance according to the acquired image information; and wherein the camera is mounted at a head and/or a tail of the vehicle.

5. The vehicle hazard avoiding apparatus according to claim 4, wherein the processor is further configured to send a notification message to a first contact when a hazard is detected.

6. The vehicle hazard avoiding apparatus according to claim 1, wherein the protection device comprises: a brake structure and a locking structure, wherein the brake structure is configured to reduce a wheel speed, and the locking structure is configured to securely lock a stationary wheel.

7. The vehicle hazard avoiding apparatus according to claim 6, wherein the protection device further comprises: a wrapping protector configured to eject a material capable of wrapping up a user in the vehicle in response to a hazard detected by the hazard identification device.

8. The vehicle hazard avoiding apparatus according to claim 7, wherein the material is a high polymer material.

9. The vehicle hazard avoiding apparatus according to claim 7, wherein the material has a non-sealed reticulated ellipsoid structure.

10. The vehicle hazard avoiding apparatus according to claim 1, wherein the vehicle is a children's vehicle.

11. A vehicle hazard avoiding method, in which the vehicle hazard avoiding apparatus of claim 1 is applied, the method comprising:
detecting whether a hazard is present within a first distance according to the acquired image information; and
sending a locking signal to lock wheels of the vehicle under the condition that a hazard is present within the first distance.

12. The method according to claim 11, wherein after detecting whether a hazard is present within the first distance according to the acquired image information, the method further comprises:
sending an alarm sound under the condition that a hazard is present within the first distance, and detecting whether a hazard is present within the first distance according to the acquired image information at a time interval of a first time.

13. The method according to claim 11, wherein the step of detecting whether a hazard is present within a first distance according to the acquired image information comprises:
determining whether a distance between a first vehicle and a second vehicle is smaller than the first distance according to the acquired image information;
determining, under the condition that the distance is smaller than the first distance, a travel speed of the second vehicle according to the acquired image information; and
detecting whether the travel speed exceeds a first travel speed.

14. The method according to claim 13, wherein after detecting whether the travel speed exceeds the first travel speed, the method further comprises:
determining, under the condition that the travel speed does not exceed the first travel speed, whether an intersection region of the second vehicle with the first vehicle is present according to the travel speed and a moving speed of the first vehicle, wherein the intersection region is a region where a collision is likely to occur.

15. The method according to claim 11, wherein after detecting whether a hazard is present within the first distance according to the acquired image information, the method further comprises:
sending a notification message to a first contact under the condition that a hazard is detected within the first distance.

16. The method according to claim 11, wherein after detecting whether a hazard is present within the first distance according to the acquired image information, the method further comprises:
sending, under the condition that a hazard is present within the first distance, a control signal to control ejection of a material capable of wrapping up a user in the vehicle.

17. A storage medium storing a computer program thereon, wherein the computer program, when executed by a processor, causes steps of the method according to claim 11 to be implemented.
